(19) United States
(12) Patent Application Publication
(10) Pub. No.: US 2003/0008111 A1
(43) Pub. Date: Jan. 9, 2003

(54) RECORDING MEDIUM AND IMAGE FORMING METHOD USING THE SAME

(76) Inventors: HITOSHI YOSHINO, ZAMA-SHI (JP); YUJI KONDO, MACHIDA-SHI (JP); HIROSHI TOMIOKA, TOKYO (JP)

Correspondence Address: FITZPATRICK CELLA HARPER & SCINTO, 30 ROCKEFELLER PLAZA, NEW YORK, NY, 10112, US

(21) Appl. No.: 09/337,354

(22) Filed: Jun. 21, 1999

(30) Foreign Application Priority Data
Jun. 22, 1998 (JP) 10-174778

(51) Int. Cl. B32B 3/00; B32B 27/14

(52) U.S. Cl. 428/195; 428/204

(57) ABSTRACT

Provided is a recording medium comprising alumina hydrate, wherein said alumina hydrate having a boehmite structure and containing silica within alumina hydrate particles, in part of or a whole of said alumina hydrate particles, and the crystallinity of said alumina hydrate obtained by an X-ray diffraction analysis of said recording medium is in a range of from 15 to 80.

### BACKGROUND OF THE INVENTION

1. Field of the Invention

The present invention relates to a recording medium suitable for recording by using ink, in particular to a recording medium suitable for ink-jet recording system, and to an image forming method using the same.

2. Related Background Art

In recent years, the ink-jet recording process to make a record of images, characters or the like by ejecting minute droplets of ink in accordance with various operating principles and depositing them to a recording medium such as paper has features in recording high in speed, low in noise, easy of multi-color recording and large in the feasibility of a recorded pattern and has no need for development or fixation, and then it has been rapidly spreading in various uses represented by information device as recorder of various images. Furthermore, because it is possible to obtain an image formed by the multi-color ink-jet process the quality of which is almost the same as in multi-color printing by the plate-making process and print by the color photography process and because it can be obtain less expensive than that in a general multi-color printing or print for a small number of prepared records, so that the multi-color ink-jet process is being widely applied to the field of a full-color image record.

In the ink-jet recording system, an improvement in recorders and recording methods has been carried out with accelerating of recording speed, more precise and full-colored record, but higher grade characteristics has become in request also for a recording medium. To solve such problems, multifarious shapes of recording medium have been thus far proposed.

For example, Japanese Patent Application Laid-Open No. 55-5830 discloses an ink-jet recording sheet with an ink absorbing layer provided on the surface of a substrate and Japanese Patent Application Laid-Open No. 55-51583 discloses an example in which amorphous silica is used as pigment in a covering layer.

In U.S. Pat. Nos. 4,879,166, 5,104,730, Japanese Patent Application Laid-Open Nos. 2-276670, 3-215082 and 3-281383 and further Japanese Patent Application Laid-Open Nos. 7-089221, 7-172038, 7-232473, 7-232474, 7-232475, 8-132731, 8-174993, 9-066664, 9-076628, 9-086035 and 9-099627 applied by the present inventors, a recording sheet with an ink receiving layer using alumina hydrate having a pseudo-boehmite boehmite structure and the like is proposed.

In Japanese Patent Application Laid-Open Nos. 5-58619, 9-234948 and 10-71764, a recording medium with an ink receiving layer containing amorphous silica alumina is proposed.

In Japanese Patent Application Laid-Open No. 60-219084, a recording medium with an ink-receiving layer containing cationic colloidal silica is proposed.

In U.S. Pat. No. 4,879,166, EP-A-298424 and Japanese Patent Application Laid-Open Nos. 1-97678, 6-48016 and 6-55829, a recording medium using alumina hydrate having a specific adsorbing ability and silica in combination is proposed.

In U.S. Pat. No. 5,104,730, EP-A-407720 and Japanese Patent Application Laid-Open Nos. 2-276671, 3-281383, 4-115984 and 4-115985, a recording medium with a porous pulverized silica layer laminated on a porous alumina layer is proposed.

In Japanese Patent Application Laid-Open Nos. 62-174183, 1-141783, 6-255235 and 6-270530, a recording medium containing silica and alumina is proposed.

In U.S. Pat. No. 5,463,178, EP-A-634287 and Japanese Patent Application Laid-Open No. 7-76162, a recording medium with a layer composed of a silica gel made layer laminated on a porous alumina hydrate layer is proposed.

In Japanese Patent Application Laid-Open Nos. 8-2087 and 8-2091, a recording medium with a silica gel layer laminated on a porous alumina hydrate layer in which a ragged surface is formed on an ink receiving layer and resin particles or silica particles are contained in the silica gel layer is proposed.

In Japanese Patent Application Laid-Open No. 8-290654, a recording medium with a 5-100 μm thick porous alumina hydrate layer formed on a 1-10 μm thick silica gel layer structured of mutually connected silica primary particles but containing no secondary particle laminated on a paper substrate is proposed.

In some cases, however, a conventional recording media have the following problems.

1. Though being slightly cationic and fixative for dyes, the recording medium with an ink receiving layer containing amorphous silica alumina becomes so low in cationicity when a content of alumina is low that a poor fixing power to dyes may result in occurrence of bleeding. With respect to such a problem, according to the conventional method described in Japanese Patent Application Laid-Open No. 5-58619, the surface of an aluminosilicate is treated with a compound of a bi- or more valent metal, for example, alumina, to control the amount of anions. Besides, according to the conventional method described in Japanese Patent Application Laid-Open No. 9-234948, addition of a cationic substance to an ink receiving layer composed of silica alumina has improved an ink fixation. In any of improvements, no fixation is often obtained in singly used cases of silica alumina.

2. Cationic silica is formed from depositing a substance showing a cationicity such as alumina on a surface of colloidal silica. The surface electric charge becomes positive and a fixation for a dye in ink becomes relatively good, but the characteristics of silica will be lost when a covering layer of alumina or the like is thickened to increase the surface positive charge, so repelling may occur due to decreasing an affinity to ink. Furthermore, since alumina coating is performed after the formation of silica, there is also a problem of an increase in the number of steps for manufacturing materials.

3. The recording medium using a mixture of silica and alumina has problems that mixing them in an aqueous dispersion causes a gelation or leads to a damage to dispersion stability because of reverse charges between silica and alumina in the aqueous dispersion. Besides, unless particles of silica and alumina used are extremely small in diameter, the ink receiving layer formed by using them may become turbid or decreases in glossiness. However, since a smaller particle diameter of the silica and alumina does not allow the pore radius and the pore volume of the ink receiving layer to be increased, however, the ink absorbency may become poor in turn.

4. The above-mentioned recording medium with a silica layer laminated on an alumina layer is based on the technical idea that the formation of the silica layer on the alumina layer protects the ink receiving layer from being damaged. However, there is a problem that thickening the silica layer to promote the score preventive effect makes the ink receiving layer turbid and thinning the silica layer to prevent the turbidness reduces the score preventive effect. Furthermore, there is also a problem that a smaller pore radius of the silica layer lowers the ink-absorbency and by contraries a larger pore radius of the silica layer results in peeling of the silica layer or easy occurrence of powder drop-off.

### SUMMARY OF THE INVENTION

The present invention is made to solve these problems and has an object in providing a recording medium wide in the selection of ink, high in the optical density of printing portions, good in the transparency of an ink receiving layer in the case of employing an arrangement with an ink receiving layer and little in crack, powder drop-off, curling or the like and an image forming method using the same.

The above object can be achieved according to the following present invention.

Namely, according to the present invention there is provided a recording medium containing alumina hydrate wherein the alumina hydrate having a boehmite structure and containing silica within alumina hydrate particles, in part of or whole of the alumina hydrate particles, and moreover, its crystallinity analyzed on the X-ray diffraction of the recording medium lies in a range of from 15 to 80.

According to the present invention there is also provided an image forming method for recording by ejecting an ink through a minute orifice and depositing it to a recording medium, in which a recording medium as described above is used as the recording medium.

### DESCRIPTION OF THE PREFERRED EMBODIMENTS

The recording medium of the present invention may has an arrangement with an ink receiving layer provided on a substrate, for example wherein the ink receiving layer comprises alumina hydrate particles or wherein alumina hydrate particles are added to inside the fibrous layer made of paper or the like.

As alumina hydrate particles, alumina hydrate particles having a boehmite structure and containing silica (hereinafter, referred to as “silica-contained alumina hydrate particles”) alone or a combination of at least two type alumina hydrate particles comprising such composed alumina hydrate particles and alumina hydrate particles, though having a boehmite structure, but containing no silica (hereinafter, referred to as “silica-free alumina hydrate particles”) can be utilized for the formation of a recording medium. Incidentally, these both types of alumina hydrate particles are generically referred to as “alumina hydrate particles”.

According to the recording medium of the present invention, at least alumina hydrate particles having a boehmite structure and containing silica are used as alumina hydrate particles and the crystallinity of alumina hydrate as a whole recording medium is set in a specific range, so that there can be obtained a recording medium, which is good not only in characteristics related to ink-absorbency, solid-print uniformity and bleeding (dot diameter), beading and repelling and recording characteristics such as fixation for coloring materials, but also in characteristics related to transparency, damage resistance and the occurrence of crack or powder drop-off, which has widened selection of ink types and which is further improved in various characteristics in a well-balanced manner.

Because of being positively charged, the alumina hydrate is advantageous in that a fixation for a dye in ink is good, an image excellent in coloring performance is obtained and no such a problem as browning of black ink or light resistance occurs. Thus, use of alumina hydrate particles having a boehmite structure shown by the X-ray diffraction method in the present invention enables a recording medium good in both the adsorption for a dye and the ink-absorbency and also good in the transparency of an ink receiving layer for an arrangement with the ink receiving layer to be obtained.

Incidentally, the alumina hydrate is defined in terms of the following general formula

A1₂O₃₋ₙ(OH)₂ₙ·mH₂O

in which n represents any one of integers 0 to 3, m represents a value of 0 to 10, preferably a value of 0 to 5 and both m and n take no value of 0 simultaneously. The expression of mH₂O represents a removable water phase mostly taking no part in the formation of a crystal lattice and accordingly m can also take a fractional value.

In general, a crystal of alumina hydrate having a boehmite structure is a layered compound with its (020) plane forming a macro-plane and indicates a diffraction peak peculiar to the X-ray diffraction pattern. In addition to a perfect boehmite, the boehmite structure can also take a structure containing an excess of water between the layers of (020) planes, referred to as pseudo-boehmite. The X-ray diffraction pattern of this pseudo-boehmite indicates a broader diffraction peak than that of a perfect boehmite. Since no clear distinction can be made between a perfect boehmite and a pseudo-boehmite, the present invention refers as both of them to a boehmite structure inclusively unless otherwise stated.

The present inventors has proposed a recording medium using alumina hydrate of a boehmite structure. The present invention is its improvement and relates to an addition of silica to alumina hydrate of a boehmite structure. Examinations by the present inventors reveals that the boehmite structure is retained in particles even if silica contained and characteristics of a recording medium can be further promoted by the content of silica while a boehmite structure retained like this. Incidentally, it is confirmed from the above X-ray diffraction that the boehmite structure is retained. The reason why the boehmite structure is retained even when silica contained is obscure, but the inventors of the present invention conjecture there being also a possibility of a structure that silica is incorporated between the layers of the boehmite. Thus, it is essential for silica-contained alumina hydrate particles used in the present invention to have a boehmite structure.

A method for producing silica-contained hydrate particles used in the present invention is not especially restricted, but can be freely selected, for example, from methods such as a method comprising the steps of sedimentation, filtration and washing after the addition of an aluminum salt such as aluminum sulfate to an alkali silicate such as sodium silicate as described in Japanese Patent Application Laid-Open No. 5-58619, a method comprising the steps of hydrolyzing an alumina C₂-C₂₀alcoholate and adding orthosilicic acid during or after the hydrolysis as described in U.S. Pat. No. 5,045,519 and Japanese Patent Application Laid-Open No. 2-144145, a method comprising the steps of adding an alkali metal silicate to an aqueous solution of alkali metal aluminate and allowing the mixture to react at or below 60° C. to obtain silica alumina having pores of 10 nm or smaller in radius, as described in Japanese Patent Application Laid-Open No. 6-227811 and a method comprising the steps of mixing the hydrolyzate of an aluminum alkoxide with the hydrolyzate of an silicic acid alkoxide. Besides, it is also applicable to subject a liquid dispersion of formed silica alumina to a heating treatment and to use a dried powder formed by the spray dry.

Like this, it is essential that the silica-contained alumina hydrate particles used in the present invention indicates a boehmite structure and important in its production that a composite reaction between silica and alumina is so arranged as not to occur in the least possible. As described in Japanese Patent Application Laid-Open No. 9-234948, for example, according to a method comprising the steps of dispersing an aluminum alkoxide into an organic solvent containing an acid catalyzer, then dispersing this together with a silicic acid alkoxide and a definite amount of water into an organic solvent containing an acid catalyzer and adding a specific amount of water containing an acid catalyzer to the liquid mixture before the hydrolysis, the formation of a bond between silicon-oxygen-aluminum (—Si—O—Al—) due to the complexing of silica alumina makes a boehmite structure difficult in formation, so that silica-contained alumina hydrate indicating a boehmite structure to be used in the present invention is difficult to obtain.

The alumina hydrate contained in the recording medium of the present invention has its crystallinity within the range between 15 and 80 as a whole. If the crystallinity lies within this range, the optical density of the printing portion becomes high and the occurrence of bleeding, beading or repelling can be sufficiently minimized to acquire a desired effect even when either a pigment ink or a dye ink is used as a coloring material. A further preferable range of crystallinity is 20 to 70. If the crystallinity lies within this range, the roundness of a printing dot elevates, a tint change relative to a density change reduces and the occurrence of a curl or tack in a recording medium after the printing even when printing is conducted using dense and thin inks or in small droplets and small and large droplets in combination.

Here, as shown in Japanese Patent Application Laid-Open No. 8-132731 by the present inventors, the crystallinity of a recording medium is a quantity that can be evaluated on the basis of the ratio between the intensity of 2θ=10° and the peak intensity of the (020) plane appearing near 2θ=14 to 15° in the X-ray diffraction pattern by the CuKa rays measured on a pulverized recording medium. This crystallinity is a physical quantity corresponding to the ratio between the crystal portion and the amorphous portion of alumina hydrate present in a recording medium.

Similarly, the “bleeding” referred to as in the present invention means that the portion colored with a dye becomes wider (larger) than the printed area where a solid printing is conducted on a definite area, the “beading” means a phenomenon in which a granular unevenness in density appears on account of the aggregation of ink drops occurring in the solid print portion and “repelling” means that the uncolored portion occurs in the solid print portions. Furthermore, with an arrangement with an ink receiving layer, the recording medium of the present invention has an effect that the ink receiving layer becomes resistant to a scratch when rubbed. What is more, none of the various recording characteristics mentioned above is damaged in any case. A proportion of silica in a recording medium is preferably equal to or greater than 0.1% by weight relative to the total weight of alumina hydrate particles (a whole weight thereof in a case of using silica-contained alumina hydrate particle alone, and a total weight in a case of using silica-contained alumina hydrate particle and silica-free alumina hydrate particle in combination). The total weight equal to or greater than 0.1% by weight enables the ink receptor layer to sufficiently obtain a property of being less subject to damages. In Japanese Patent Application Laid-Open Nos. 9-316396 and 9-316397, the reason for this is conjectured on citing Japanese Patent Application Laid-Open No. 62-32157 to lie in that the hardness and crack resistance is promoted since the film stress by the feather-like shape of colloidal alumina is alleviated. On considering that a damage preventive effect develops even by the addition of so slight an amount as 0.1% by weight or greater, a powder drop-off can be prevented by the internal addition into the fibrous layer and the addition of silica reduces the crystallinity of the recording medium, which will be described below, the present inventors suppose that there would be a possibility that some change is caused in the property of the crystal structure or the particle surface of alumina hydrate.

A further preferable range of the silica content is equal to or greater than 1% by weight for the total weight of alumina hydrate particles. In this range, the fixation of an image printed by an ink containing a pigment as coloring material can be improved further and the fall-off of a coloring material is eliminated even by rubbing the printing portion. If the silica content is equal to or greater than 5% by weight, breeding becomes further unlikely to occur at the boundary of the printing portion even when using concurrently a pigment with a dye ink for coloring material.

Incidentally, in U.S. Pat. No. 5,045,519 and Japanese Patent Laid-Open Application No. 2-144145, there is described an aluminosilicate containing alumina hydrate of a pseudo-boehmite structure. As described in the same publications, with increasing content of silica in aluminosilicate having a boehmite structure analyzed by an X-ray diffraction analysis, a change proceeds from a boehmite structure to an amorphous structure. According to the knowledge of the present inventors about the relation between the silica content and the crystallinity of alumina hydrate, the crystallinity of alumina hydrate tends to decrease with increasing content of silica.

Here, if the content of silica in silica-contained alumina hydrate particles exceeds 30% by weight, the crystallinity of alumina hydrate contained in the obtained recording medium has a possibility of falling less than 15 and accordingly the content of silica is preferably below 30% by weight for silica-contained alumina hydrate alone, the first aspect of the present invention.

As the second aspect of the present invention, there is a method of using a mixture of silica-contained alumina hydrate and silica-free alumina hydrate. Also when this method employed, the relation between the crystallinity of the alumina hydrate contained in the recording medium and the content of silica holds true also. Also in this case, if the content of silica relative to all of the alumina hydrate particles in the recording medium exceeds 30% by weight, the crystallinity of alumina hydrate contained in the obtained recording medium has a possibility of falling less than 15. Besides, to take a boehmite structure, the content of silica is preferable equal to or smaller than 50% by weight. If the content of silica exceeds this range, there are cases where the peak peculiar to the boehmite disappears in the X-ray diffraction pattern. In the present invention, though a preferable weight ratio between silica-contained and silica-free alumina hydrate particles depends on the content of silica in the employed silica-contained alumina hydrate, any mixing ratio can be used only if the crystallinity of alumina hydrate in the recording medium lies within a range of from 15 to 80. For example, the weight ratio between silica-contained and silica-free alumina hydrate particles can be selected preferably from the range between 90:10 and 10:90.

As described in the literature (Rocek, J. et al.; Applied Catalysis, vol. 74, pp. 29-36, 1991), it is generally known that the boehmite in alumina hydrate takes a ciliary shape or other shapes. In the present invention, either a ciliary shape or a planar shape of alumina hydrate can be used. The shape (particle shape, particle diameter and aspect ratio) of alumina hydrate particles can be measured from a specimen for measurement prepared by dispersing alumina hydrate particles into water (for example, ion-exchange water), alcohol or the like, dropping the mixture onto a collodion film and this specimen is observed under a transmission type electron microscope.

According to the knowledge of the present inventors, the planar shape has a better dispersibility into water than the hairy bundle (ciliary shape) and becomes larger in pore volume and wider in pore radius distribution because of randomly oriented alumina hydrate particles on the formation of an ink receptor layer, so that the planar shape is preferable. Here, a hairy bundle shape means a condition of needle-shaped alumina hydrate particles gathering like a hairy bundle in side-to-side contacts.

An aspect ratio of a planar particles can be evaluated by the method defined in Japanese Patent Publication No. 5-16015. The aspect ratio represents the ratio of the diameter to the thickness of a particle. Here, the diameter means the diameter of a circle having an area equal to the projected area of an alumina hydrate particle when observed on a microscope or an electron microscope. A slenderness ratio is a ratio of a minimum diameter to a maximum diameter of a flat plane when observed as with the aspect ratio. In the case of a hairy bundle shape, the aspect ratio can be determined by measuring diameters of the top and bottom circles and a length of cylinder constituted by each acicular particle of alumina hydrate constituting the hairly bundle and calculating the ratio of the length to the diameter. The most preferable shape of an alumina hydrate particle is so chosen that the average aspect ratio and the average particle diameter are in a range of from 3 to 10 and in a range of from 1 to 50 nm for a planar shape or the average aspect ratio, respectively, and the average particle length are in a range of from 3 to 10 and in a range of from 1 to 50 nm for a hairy bundle shape, respectively. If the average aspect ratio lies in the above range, gaps are formed between the particles on the formation of an ink receiving layer or on the internal addition to a fibrous layer, so that a porous structure wide in the pore radius distribution can be easily formed. If the average particle diameter or the average particle length lies in the above range, a porous structure large in pore volume can be produced similarly. If the average aspect ratio is smaller than the lower limit of the above range, the pore radius distribution range of an ink receiving layer is narrowed, whereas it becomes difficult to produce alumina hydrate particles with the particle diameter kept almost equal if the average ratio is greater than the upper limit of the above range. If the average particle diameter or the average particle length is smaller than the lower limit of the above range, the pore radius distribution is easily narrowed, whereas the absorbing property for a printed dye may be easily lowered if greater than the upper limit of the above range.

A recording medium with an ink receiving layer provided on a substrate can be obtained by forming an ink-receiving layer on a substrate through the coating and drying steps of a dispersion prepared by using at least silica-contained alumina hydrate particles.

A recording medium composed by the internal addition of silica-contained alumina hydrate particles or a mixture of silica-contained alumina hydrate particles and silica-free alumina hydrate particles into a fibrous layer can be obtained, for example, by impregnating the fibrous layer made of a fibrous substance with the above dispersion comprising silica-contained alumina hydrate particles and drying it.

In the present invention, the ink receiving layer can be made into a monolayer structure or a multilayer structure. In a case that the ink-receiving layer is of a multi-layer structure, it is preferable that at least the outer-most layer comprises silica-contained alumina hydrate or a mixture of silica-contained alumina hydrate particles and silica-free alumina hydrate for improving a coloring performance, a damage preventive effect of a surface and the fixation for coloring material in a pigment ink.

Next, an arrangement with an ink receiving layer will be described in advance. A BET specific surface area, a pore radius distribution, a pore volume and a isothermal nitrogen adsorption·desorption curve can be simultaneously measured by the nitrogen adsorption·desorption method. The BET specific surface area is preferably in a range of from 70 to 300 m²/g. If the BET specific surface area is smaller than the above range, the ink receiving layer becomes turbid or the adsorbing points for an ink dye fall short, so that the water-fastness of an image becomes insufficient. If the BET specific surface area is smaller than the above range, a crack becomes likely to occur in the ink receiving layer.

In the present invention, first to third pore structures shown below can be used, while one of them can be selected, or two or more can be jointly used according to the need. The pore radius, the pore volume and the pore radius distribution mentioned in the present invention are values measured by the nitrogen adsorption-desorption method at the time of adsorption or desorption.

As described in Japanese Patent No. 2714352, the first pore structure in the present invention is of an ink receiving layer having an average pore radius of 2.0 to 20.0 nm and a half-value width of 2.0 to 15.0 nm in the pore radius distribution curve. Here, as shown in Japanese Patent Application Laid-Open No. 51-38298 and Japanese Patent Application Laid-Open No. 4-202011, the average pore radius can be measured from the pore volume and the BET specific surface area. Besides, the half-value width of the pore radius distribution curve indicates a width of a frequency of the pore radius at a half of the frequency of the average pore radius. As described in Japanese Patent Application Laid-Open No. 4-267180 and Japanese Patent Application Laid-Open No. 5-16517, a dye in ink is selectively adsorbed to pores having a specific radius, but the selection of usable dyes becomes wider if the average pore radius and the half-value width lie in the respective ranges, so that even use of a hydrophobic or hydrophilic dye brings about hardly any occurrence of bleeding, beading or repelling and the optical density and the dot diameter becomes uniform. If the average pore radius is greater than the above range, the adsorbing property and/or fixing property for a dye in ink lowers and bleeding may become likely to occur, whereas the absorbing property for an ink lowers and beading may become likely to occur if smaller than the above range. If the half-valve width is greater than the above range, the absorbing property of the dye in ink lowers. On the other hand, if the half-value width is smaller than the above range, the absorbing property of solvent component in ink lowers.

In forming an ink receiving layer having the above wide pore radius distribution, the method shown, for example, in Japanese Patent No. 2714352 can be used.

As described in Japanese Patent No. 2714350, the second pore structure in the present invention is of a structure having two or more peaks in the pore radius distribution of the ink receiving layer. The solvent component in the ink is absorbed at relatively large pores and the dye in the ink is absorbed at relatively small pores. One of the peak lies in a pore radius range of preferably smaller than 10.0 nm and more preferably 1.0 to 6.0 nm. In this range, the dye adsorption is speeded up. The other peak lies preferably in a pore radius range of from 10.0 to 20.0 nm. In this range, the ink absorbing rate is accelerated. When the former peak is shifted larger than the above range, the adsorbing and/or fixing property for a coloring material such as dye ink lowers, so that bleeding or beading may become likely to occur in an image. On the other hand, when the latter peak is shifted smaller than the above range, the absorbing property for the solvent component in ink lowers, so that an ink is difficult to dry and the surface of the ink receiving layer fails to be dried after the printed medium is carried out from an apparatus. When larger than the above range, fissures may become likely to occur in the ink receiving layer.

The peak pore volume ratio of pores 10.0 nm or smaller in radius (volume ratio of the peak 2) can be calculated by measuring the pore volume of the peak part giving a maximum value of 10.0 nm or smaller and finding its ratio to the total volume. To simultaneously satisfy the ink-absorbency and the dye fixation, it is preferable that the pore volume having pore radius of 10.0 nm or smaller, lies in a range of from 0.1 to 10% based on the total pore volume and more preferably in a range of from 1 to 5%. In this range, the ink absorbing rate and the dye adsorbing rate is accelerated, so that a finger coming touch with the ink receiving layer is not stained with a coloring material even immediately after the printing. As a method for forming an ink receiving layer with two or more peaks present in the above pore radius distribution, the method disclosed, for example, in Japanese Patent No. 2714350 can be used. As another method, there can be used a method comprising mixing alumina hydrate particles having a peak in a radius range of from 10.0 nm to 20.0 nm with alumina hydrate particles having a peak in a radius range of from smaller than 10.0 nm in the pore radius distribution.

As described in Japanese Patent Application Laid-Open No. 9-66664, a third pore structure in the present invention is of a structure in which an ink receiving layer has voids inside, and the voids are linked with the surface of the ink receiving layer through pores having a smaller radius than that of the voids and communicate with the outside. The maximum peak of the pore radius distribution curve in the ink receiving layer lies preferably in a radius range of from 2.0 to 20.0 nm. The amount of absorbed water in the ink receiving layer lies preferably in a range of from 0.4 to 1.0 cm³/g. In this range, an overflow of ink can be prevented in case of multiple printing by using a large amount of ink repeatedly like multi-color printing. A range of from 0.6 to 0.9 cm³/g is more preferable. In this range, crack or deformation of the ink receiving layer before and after the printing can be prevented. Furthermore, the in-plane diffusion coefficient lies preferably in a range of from 0.7 to 1.0. In this range, the ink absorbing rate at and after second color printing does not lower in the case of multiple printing by means of a high speed printer. With this pore structure, for example, the ink absorbing rate at and after second color printing does not lower even when the multiple printing with inks is conducted at a interval of 400 msec or shorter and in addition to the above the dot diameters and dot shapes of individual colors become constant independently of the printing order. As a method for forming this ink receiving layer with a cavity provided inside, the method described, for example, in Japanese Patent Application Laid-Open No. 9-66664 can be used.

Here, the following characteristics are common in the first to third pore structures of the present invention. The total pore volume of the ink receiving layer lies preferably in a range of from 0.3 to 1.0 cm³/g. In this range, crack or powder drop-off decreases and the ink absorbing rate in multiple printing is accelerated. A range of from 0.4 to 0.6 cm³/g is further preferable for an improvement in the ink-absorbency, tint and transparency. If the pore volume of an ink receiving layer is larger than the above range, crack or powder drop-off becomes likely to occur, whereas the absorbing property for ink may become likely to lower if smaller than the above range. Besides, the pore volume for pores having a radius ranging from 2.0 to 20.0 nm, is preferably equal to or greater than 80% of the total volume. In this range, the ink-absorbing rate and the adsorbing rate for a coloring material are both improved and boundary bleeding becomes unlikely to occur independently of coloring materials. Here, the boundary bleeding means that coloring materials are mixed with each other at the boundary when solid-print patterns are printed so as to adjoin in different colors.

Furthermore, the pore volume of the ink receiving layer is preferably equal to or greater than 8 cm³/m². In this range, a color drabness at the printing portion disappears. Below the above range, ink may overflow from the ink receiving layer, and then bleeding may occur easily in an image in some cases. Since the pore structure or the like of the ink receiving layer varies with various manufacturing conditions such as, e.g. type and mixed amount of a binder, concentration, viscosity and dispersed conditions of a coating liquid, coating apparatus, coating head, coating amount and blow amount, temperature and blowing direction of a dry blast, the manufacturing conditions can be appropriately selected corresponding to desired characteristics of the ink receiving layer.

In the formation of a recording medium by using alumina hydrate particles, various additives can be added, for example, into a dispersion of alumina hydrate particles for a joint use. As needed, additives can be selected freely from the group consisting of various metal oxides, salts of di- or more valent metals and cationic organic substances. Preferred examples of metal oxides include oxides such as silica, boria, silica boria, magnesia, silica magnesia, titania, zirconia and zinc oxide; and hydroxides. Preferred examples of salts of di- or more valent metals include salts such as calcium carbonate and barium sulfate; halides such as magnesium chloride, calcium bromide, calcium nitrate, calcium iodide, zinc chloride, zinc bromide, and zinc iodide; kaoline; and talc. Preferred examples of cationic organic substances include quaternary ammonium salts, polyamines and alkyl amines. The added amount of additives is preferably, for example, equal to or smaller than 20% by weight relative to the total amount of alumina hydrate particles. As binders used in the present invention, one or more types thereof can be freely selected from water-soluble polymers and used. For example, polyvinyl alcohols or modified products thereof; starch and modified products thereof; gelatin and modified products thereof, casein and modified products thereof; gum arabic; cellulose derivatives such as carboxymethyl cellulose; polyvinyl pyrrolidone; maleic anhydride or its copolymers; water-soluble polymers such as acrylic acid ester copolymers; and water dispersible polymers such as conjugated diene copolymer latices such as SBR latex, functional group polymer latices and vinyl copolymer latices such as ethylene-vinyl acetate copolymers are preferable.

The mixing ratio of alumina hydrate particles to binders lies preferably in a range of from 5:1 to 20:1 by weight. In this range, the ink absorbing rate of a recording medium becomes faster and the optical density of the printing portion becomes higher. If the amount of binders is smaller than the above range, the mechanical strength of the ink receiving layer falls short, so that a fissure or powder drop-off becomes likely to occur. If that of binders is greater than the above range, the pore volume decreases, so that the absorbed amount of ink may become likely to lower. On considering the ink-absorbency and the preventive effect to cracks in bending a recording medium, a range of from 7:1 to 15:1 is better than the above range. In the present invention, a further addition to the ink receiving layer is also permissible of a pigment dispersant, thickener, pH adjuster, lubricant, fluid modifier, surfactant, defoaming agent, water-proofing agent, foam inhibitor, releasing agent, foaming agent, penetrating agent, coloring dye, optical whitening agent, UV absorbent, antioxidant, antiseptics and antimold as needed and these can be added to a dispersion of alumina hydrate particles for use. A water-proofing agent can be freely selected from publicly-known materials such as halogenated quaternary ammonium salts and quaternary ammonium salt polymers and used.

As a substrate used to form an ink receiving layer in the present invention, any kind of paper such as a moderately sized paper, non-sized paper and resin coated paper using polyethylene or the like; or any sheet-like material such as thermoplastic film can be used and there is no special restriction. Examples of thermoplastic films may include transparent films of polyesters, polystyrenes, polyvinyl chlorides, polymethyl methacrylates, cellulose acetates, polyethylenes, polycarbonates or the like and sheets opaqued by the filling of a pigment or the minute bubbling.

A treating method for dispersing alumina hydrate particles into a liquid in the preparation of a dispersion containing alumina hydrate particles to be applied on a substrate can be selected and used from methods generally used for dispersion. As a method or apparatus employed, a homomixer, rotary vanes or the like used for a gentle agitation is better than a grinder type dispersing machine such as ball mill or sand mill. Although depending on the viscosity, amount and volume of a dispersion, a shear stress to be applied lies preferably in a range of from 0.1 to 100.0 N/m² (1 to 1,000 dyn/cm²). In this range, the viscosity of a dispersion of alumina hydrate particles can be reduced without a change in the crystal structure of an alumina hydrate. Furthermore, since the particle diameter of alumina hydrate particles can be minimized sufficiently, binding points among alumina hydrate particles, a binder, a substrate and other components can be increased. Accordingly, the occurrence of a crack or powder drop-off can be suppressed. Above the upper limit of the above range, the dispersion gels or the crystal structure of alumina hydrate changes into an amorphous one. Below the lower limit of the above range, the dispersion is so insufficient that a precipitate becomes likely to occur in the dispersion and the aggregated particles remaining in a recording medium may induce the occurrence of a haze and a decrease in transparency, thus easily resulting in the occurrence of a crack and the falling of particles.

A range of from 0.1 to 50.0 N/m² is still better than the above range. In this range, since the pore volume in a porous structure obtained from alumina hydrate is not reduced and moreover aggregated particles of alumina hydrate can be broken into minute particles, an occurrence of macro-radius pores in the recording medium is prevented, peeling or crack in bending can be prevented and moreover a haze caused by large particles in the recording medium can be reduced. The best is a range of from 0.1 to 20.0 N/M². In this range, the mixing ratio of alumina hydrate particles to a binder can be set constant, powder drop-off or crack can be prevented and moreover the optical density of a printed dot or the dot diameter can be made uniform.

Although depending on an amount of a dispersion, a size of a vessel, temperature of a dispersion and the like, a dispersing time is preferably equal to or shorter than 30 hours from the standpoint of preventing a change in crystal structure. Furthermore, if equal to or shorter than 10 hours, the pore structure can be regulated to the above range. During the dispersing treatment, the temperature of a dispersion may be kept constant by cooling or warming. Although depending on the dispersing treatment method, material and viscosity, preferred temperatures are ranging from 10 to 100° C. Below the above range, the dispersing treatment is insufficient or aggregation occurs. Above this range, gelation occurs or the crystal structure changes into an amorphous one. In the present invention, as a coating method for a dispersion of alumina hydrate in the formation of an ink receiving layer can be employed a blade coater, air-knife coater, roll coater, brush coater, curtain coater, bar coater, gravure coater, spray device or the like. By reason of an improvement in ink absorbency, it is preferable that the coating amount of a dispersion lies in 0.5 to 60 g/m² in terms of a dried solid component and a range of from 5 to 45 g/m² is further preferable since the ink absorbing rate is accelerated and crack and powder drop-off is further eliminated. As needed, it is permissible to improve the surface smoothness of the ink receiving layer by using a calendar roll after the coating and to promote a glossiness of the surface by the cast molding. Furthermore, as described in Japanese Patent Application Laid-Open Nos. 63-151476, 7-82694, 8-72388, 8-164668, 9-30110, 9-58116, 9-136483, 10-16377 and 10-71762, a method of transcripting the smooth surface of a film or the like to the ink receiving layer is also possible. Silica-contained alumina hydrate particles used in the present invention also has a merit that a releasing property is good at the time of cast molding or the like and then stain of a cast drum is unlikely to occur. Furthermore, a heating step as described in Japanese Patent Application Laid-Open No. 9-86035 can be added as needed.

In the present invention, silica-contained alumina hydrate particles or a mixture of silica-contained alumina hydrate particles and silica-free alumina hydrate particles can be internally added to a fibrous substance either as a whole or in part. For coloration and preventing of powder drop-off, it is preferable that silica-contained alumina hydrate particles or a mixture of silica-contained alumina hydrate particles and silica-free alumina hydrate particles is contained at least near the surface of a fibrous substance.

The method for allowing silica-contained alumina hydrate particles or a mixture of silica-contained alumina hydrate particles and silica-free alumina hydrate particles to be contained near the surface of a fibrous substance includes a way to increase the amount of silica-contained alumina hydrate particles or the like present near the surface by adjusting the conditions for making paper from a slurry containing a fibrous substance and a way to add a dispersion containing silica-contained alumina hydrate particles or the like to the fibrous substance obtained from the paper-making through the size press or surface treatment and the like. However, it is not especially restricted.

Next, a recording medium composed by internally adding alumina hydrate particles to a fibrous layer will be described. The recording medium of this shape can be obtained, for example, by a method for internally adding the above dispersion of alumina hydrate particles to a layer made of the fibrous substance in the step of making paper. Applicable to this paper-making step is one or more types selected from methods using a long-net paper machine employed in general, round trunk, twin wire or the like. The amount of internally added alumina hydrate particles lying in a range of from 1 to 20% by weight of a fibrous substance expressed in terms of the dried solid component is preferable because of improving the adsorption to an ink dye. Furthermore, by reason of not only elevating the optical density of the printing portion but making the occurrence of powder drop-off difficult, a range of from 5 to 15% by weight is further preferable. As to a unit area, a range of from 0.5 to 60 g/m² expressed in terms of the dried solid component is preferable because of improving the absorbency of ink. By reason of accelerating the ink absorbing rate and eliminating the occurrence of a crack or powder drop-off, a range of from 5 to 45 g/m² is more preferable. As needed, it is also permissible to execute a size press and to improve the smoothness of the surface by using a calendar roll.

Fibrous materials are not especially restricted and their principal examples are wood pulps, but there can be also used non-wood pulps such as straw, kenaf, bamboo, hemp, mitsumata (a sort of a plant) and cotton; synthetic pulps or fibers such as polyester, polyolefine, polyamide and the like; polypeptide fibers such as silk, wool, cut gut, collagen and the like; alginates such as calcium alginate; polysaccharide fibers such as chitin; green algae fibers such as valonia cellulose; bacteria fibers such as bacteria cellulose; and further inorganic fibers such as glass fiber and ceramic fiber. Besides, the type and manufacturing method of pulp fibers is not especially restricted, and not only chemical pulps such as needle-leaved tree pulps and broad-leaved tree pulps obtained by, for example, methods of sulfite pulp (SP), alkali pulp (AP), kraft pulp (KP) and the like and SCP, but also each kind of high-yield pulps (such as SGP, BSGP, BCTMP, CTMP, CGP, TMP, RGP and CMP) or used paper or regenerated pulps such as DIP can be used according to the need.

The amount of absorbed water in this shape ranges preferably from 0.4 to 3.0 cm³/g, in which range the printed ink does not overflow even for multi-color printing and can be effectively absorbed. A range of from 0.6 to 2.0 cm³/g is further preferable and in this range neither cockling nor shrinkage occurs after the printing. Furthermore, the in-plane diffusion coefficient ranges preferably from 0.7 to 1.0 and in this range, the ink absorbing rate at and after second color printing does not decrease even when multi-color printing is conducted by means of a high speed printer and moreover multi-color printed dots become constant independently of the printing sequence, so that the tint of the mixed color part becomes constant.

In using the recording medium of the present invention with at least silica-contained alumina hydrate particles internally added to the fibrous layer, a paper-enforcing agent, yield increasing agent or coloring agent can be added, as needed. Yield increasing agent(s) can be selected from cationic yield increasing agents such as cationized starch and dicyandiamide formalin condensate and anionic yield increasing agent such as anionic polyacrylamide, or used in combination thereof.

The ink used in the image forming method of the present invention principally contains a coloring material (dye or pigment), a water-soluble organic solvent and water. Examples of dyes are preferably water-soluble dyes represented by direct dye, acid dye, basic dye, reactive dye and food color and any of them will do only if giving an image that satisfies fixation, coloring performance, distinctness, stability, light fastness and other required performances. The water-soluble dye is used by generally dissolving it in water or a solvent comprising water and water-soluble organic solvent. As the solvent component thereof, mixtures of water and various water-soluble organic solvent are preferably used, but it is preferable that the water content in ink is so adjusted as to lie in a range of from 20 to 90% by weight. Preferred examples of water-soluble organic solvents include C₁-C₄alkyl alcohols such as methyl alcohol; amides such as dimethylformamide; ketones or keto-alcohols such as acetone; ethers such as tetrahydrofuran; polyalkylene glycols such as polyethylene glycol; C₂-C₆alkylene glycols such as ethylene glycol; and lower alkyl ethers of polyhydric alcohols such as triethylene glycol monomethyl ether and trimethylene glycol monoethyl ether. In these many water-soluble organic solvents; polyhydric alcohols such as diethylene glycol, and lower alkyl ethers of polyhydric alcohols such as triethyleneglycol monomethyl ether, and triethyleneglycol monoethyl ether are preferable. Because of being greatly effective as lubricant for preventing clogs in a nozzle due to evaporation of water in ink and deposition of a water-soluble dye, polyhydric alcohols are especially preferable.

To ink, a solubilizing agent may be added also. Representative solubilizing agents are nitrogen-contained heterocyclic ketones and their aiming action is to promote the solubility in the solvent of a water-soluble dye in leaps and bounds. For example, N-methyl-2-pyrrolidine and 1,3-dimethyl-2-imidazolidinone are preferably used. Furthermore, to improve the characteristics, additives such as viscosity controlling agent, surfactant, surface tension controlling agent, pH controlling agent and resistivity regulating agent may be also added.

As methods for forming images by applying an ink composed above to the recording medium of the present invention, an ink-jet recording method, that method capable of effectively ejecting an ink through a nozzle to deposit the ink to a recording medium, can be preferably used. The method described in Japanese Patent Application Laid-Open No. 54-59936, ink-jet process wherein an abrupt volume change takes place in the ink under action of thermal energy and ink is ejected through a nozzle by using the action force due to this change of state, can be in particular effectively used.

Hereinafter, by showing examples, the present invention will be specifically described, but the present is not limited to these specific examples. Incidentally, measurements of the characteristics used in the present invention were carried out in accordance with the gist mentioned below.

(1) Crystallinity

With a recording medium installed on a specimen stand as left in the shape of a sheet or as powdered, the X-ray diffraction was measured to obtain a ratio between the intensity of a peak for the (020) plane and the intensity for 2θ=10°.

X-ray diffraction apparatus (RAD-2R, trade name, available from Rigaku Denki Co.)

Target: CuKα

Optical System: Wide angle goniometer (with graphite curved monochrometer)

Goniometric Radius: 185 mm

Slit: DS 10° RS 1° SS 0.15 mm

Tube Voltage/Current of X-Ray Power Supply: 40 kV/30 mA

Measuring Conditions:

2θ-θ method

Continuous scan with data collected at intervals of 2θ=0.002°

2θ=10° to 30°; 1°/min

(2) Pore Radius Distribution and Pore Volume

After sufficient heating and degassing of a recording medium, measurements were made using the nitrogen adsorption/desorption method.

Measuring Apparatus: AUTOSOAB 1, a product of Quantachrome Co.

(3) Absorbed Water Amount

A recording medium was cut into a 100 mm side square and ion exchange water was dropped little by little to its central part and extended uniformly by means of a spatula or the like every time for absorption. This operation was repeated till ion exchange water overflows and the ion exchange water remaining on the surface was wiped off with cloth or the like. The water absorbed amount was measured from a difference between the weight of the recording medium before and after the absorption of ion exchange water.

(4) In-Plane Diffusion Coefficient

Similarly, as in item (3) “absorbed water amount” above, a recording medium was cut into a 100 mm side square and ion exchange water was dropped little by little to its central part for absorption. It is required that the ion exchange water dropped at this time is not spread over the surface of the recording medium before water has been absorbed at the dropped point. Like the measurement of the absorbed water amount, this operation was repeated until ion exchange water overflows and the absorbed amount at one point of the recording medium was obtained from a difference between the weight of the recording medium before and after the absorption of ion exchange water. And, the in-plane diffusion coefficient was determined by calculating a value of (Absorbed amount at one point of the recording medium)/(Absorbed amount of the recording medium).

(5) Silica Content

Silica-contained alumina hydrate particles were fused into a borate, and the silica content was examined by the ICP method using SPS4000 (trade name, a product of SEIKO Electronic Co.). The silica content regarded as SiO₂ was calculated as a weight percentage to the silica-contained alumina hydrate particles.

(6) Particle Shape

Alumina hydrate particles was dispersed in ion exchange water and the thus obtained dispersion was dropped onto a collodion film to prepare a specimen. The specimen was observed under a transmission electron microscope (H-500, trade name, a product of Hitachi, Ltd.) to obtain the aspect ratio, the particle radius and the particle shape.

(7) Transparency

A haze of the recording medium obtained by coating and drying a transparent PET film with a dispersion containing alumina hydrate particles was measured using a haze meter (NDH-1001DP, trade name. a product of Nippon Denshoku Co.) in accordance with JIS K 7105.

(8) Scratch resistance

After a recording medium cut into a 297×210 mm-sized piece, the piece was rubbed 10 times with a 100 μm thick transparent PET (Lumirror, trade name, Toray Industries, Inc.) of the same size to observe visually scratch resistance. Those free from any scratch of 1 mm or more in length, those free from any scratch of 5 mm or more in length, and those with scratches of 5 mm or more in length, are ranked as A, B and C, respectively.

(9) Crack

At the completion of forming an ink receiving layer, the length of a crack in the recording medium was measured visually. Those free from any crack of 1 mm or more in length, those free from any crack of 5 mm or more in length, and those with cracks of 5 mm or more in length, are ranked as A, B and C, respectively.

(10) Powder drop-off

After a recording medium of a structure with alumina hydrate particles internally added into a fibrous layer was cut into a 297×210 mm-sized piece, the piece was bent in halves at the center to examine an occurrence of a powder drop-off. Those free from any drop-off of powder of 1 mm or more in length, those free from any drop-off of powder of 5 mm or more in length, and those with drop-off of powder of 5 mm or more in length, are ranked as A, B and C, respectively.

(11) Curl

After a recording medium cut into a 297×210 mm-sized piece, the piece was laid stationarily on a flat stand to measure the curled degree by means of a height gauge. Those of a 1 mm or less curl, those of a 3 mm or less curl and those of a curl over 3 mm are ranked as A, B and C, respectively.

(12) Tack

On touching the surface of a recording medium with fingers, the absence of adhesion and the presence of adhesion are ranked as A and C, respectively.

(13) Printing Characteristics

Printing was executed using three types of printers as shown below to estimate the following characteristics.

(a) DJ720C printer (trade name, a product of HP Co.) for small liquid-drop printing in which a pigment ink for Bk (black) and dye inks for Y (yellow), M (magenta) and C (cyan) were used, respectively.

(b) PM750C printer (trade name, a product of EPSON Co.) for dense/dilute ink printing.

(c) BJC430 printer (trade name, a product of CANON Inc.) for large/small droplet printing.

13-i) Ink-Absorbency

By using the above printers of three types, solid printing was made in a single color to four colors. On touching the record part with fingers to feel the drying conditions of ink on the surface of a recording medium after the printing, the ink-absorbency was examined. Letting the amount of ink in single color solid printing be 100%, those of ink not adhered to fingers at 300% of ink (three-color mixing), those of ink not adhered to fingers at 200% of ink (two-color mixing), those of ink not adhered to fingers at 100% of ink and those of ink adhered to fingers at 100% of ink are ranked as AA, A, B and C, respectively.

13-ii) Optical Density of Image

By using the printer (c), single color solid printing was made in Y, M, C or Bk ink at 100% of ink to estimate the optical density of image of the obtained image by a Macbeth reflection densitometer RD-918. In the case of a recording medium with an ink receiving layer provided on a transparent substrate, measurements were made by placing an electrophotographic sheet (EW-500, trade name, a product of Canon, Inc.) on surface provided with no ink receiving layer in the recording medium.

13-iii) Solid-print Uniformity, Bleeding, Beading and Repelling

After the single color or multi-color solid printing was conducted using the above printers of three types, solid-print uniformity, bleeding, beading and repelling were examined visually. The uniform density at the solid-print part and the presence of a blank failure or uneven density are ranked as A and C, respectively. No bleeding and appreciable bleeding of a coloring material from the solid printing portion are ranked as A and C, respectively. Similarly, the absence and the occurrence of beading or repelling are ranked as A and C, respectively.

13-iv) Tint Difference of Pigment Ink and Dye Ink

From a visual observation of the black 100% solid printed part obtained using the above printers of three types, the tint difference was examined. The absence of tint difference among three types of printers, the absence of tint difference between the printer (a) and one type of printer and the presence of tint difference are ranked as A, B and C, respectively.

13-v) Fixation

On touching the part of black 100% solid printing made using the printer (a), the fixation of a coloring material was estimated. The absence and the occurrence of fall-off of a coloring material are ranked as A and C, respectively. One dot printing was made with single color of Y, M, C or Bk ink by using the above printer (a). The diameter of a dot was observed on a microscope.

13-vi) Printing Density and Tint Change

By using the above printers of three types, printing of patterns with a density gradation of 128 levels ranging from 0% to 100% was made for individual colors to visually observe the tint in each level of printing density for each color. Those having the same level in tint irrespective to printing density of four colors, for three colors and for two colors, and a density-dependent tint change for every color are ranked as AA, A, B and C, respectively.

13-vii) Post-Printing Curl

After a recording medium cut into a 297×210 mm-sized piece, 100% solid printing was made on the whole surface by using the printer (c). The printed piece was laid stationarily on a flat stand to measure the curled degree with a height gauge. Those of a 1 mm or less curl, those of a 3 mm or less curl and those of a curl over 3 mm are ranked as A, B and C, respectively.

13-viii) Post-Printing Tack

After a recording medium cut into a 297×210 mm-sized piece, 100% solid printing was made on the whole surface by using the printer (c). On touching the surface of a recording medium with fingers, the absence of adhesion and the presence of adhesion are ranked as A and C, respectively.

13-ix) Post-Printing Conveyance Scratch

After a recording medium cut into a 297×210 mm-sized piece, 10 pieces were laminated on each other and conveyed in sequence on the printer (c) to visually observe scratches in each of 10 pieces. Those free from any scratch of 1 mm or more in length, those free from any scratch of 5 mm or more in length, and those with scratches of 5 mm or more in length, are ranked as A, B and C, respectively.

13-x) Post-Printing Powder drop-off

After a recording medium of a structure with alumina hydrate particles internally added into a fibrous layer was cut into 297×210 mm-sized pieces, 10 pieces were laminated on each other and conveyed in sequence on the printer (c) to visually observe the manner of powder drop-off in each of 10 pieces.

Synthetic Examples 1 to 12

In accordance with the method described in U.S. Pat. No. 4,242,271, aluminum dodexide was manufactured. The obtained aluminum dodexide was mixed with ion exchange water and ortho-silicic acid. This mixed solution was put into a reaction vessel and the above aluminum dodexide was hydrolyzed with stirring. The conditions for hydrolysis and the mixing ratio of aluminum dodexide to ortho-silicic acid are mentioned in Table 1. The suspension of this alumina hydroxide was spray-dried at an inlet temperature of 280° C. to obtain silica-contained alumina hydrate powder. The crystal structure of alumina hydrate is of boehmite and the particle shape is of a flat plate. Physical properties of the alumina hydrate were measured respectively by the above methods. The results are shown in Table 1. Synthetic Examples 6 and 12 do not contain silica.

### EXAMPLES 1 to 8

Polyvinyl alcohol (Gosenol NH18, trade name, available from The Nippon Synthetic Chemical Industry Co., Ltd.) was dissolved and dispersed into ion exchange water to obtain a 10% by weight solid component solution. Similarly, silica-contained alumina hydrate particles of Synthetic Examples 1 to 4 and 7 to 10 were dispersed into ion exchange water to obtain a 15% by weight solid component solution. The respective amounts of the liquid alumina hydrate dispersion and the liquid polyvinyl alcohol solution are weighed so as to become a weight mixing ratio of 1:10 between the solid component of polyvinyl alcohol and the solid component of alumina hydrate particle dispersion to obtain a mixed dispersion with stirring for 30 minutes using a homomixer (available from Tokushu Kika Co.) at 8,000 rpm. This mixed dispersion was die-coated on a 100 μm thick transparent PET film (Lumirror, trade name, available from Toray Industries, Inc.). The PET film coated with the dispersion was placed in a oven (available from Yamato Science Corp.) and heated/dried at 100° C. for 30 minutes to obtain a 30 μm thick ink receiving layer. Measurements and estimations of various characteristics were carried out respectively by the above methods. Results were shown in Tables 2 and 3.

### EXAMPLES 9 to 16

Silica-contained alumina hydrate particles obtained in Synthetic Examples 2 to 5 were mixed with silica-free alumina hydrate particles of Synthetic Example 6 at ratios shown in Table 4. Similarly, silica-contained alumina hydrate particles obtained in Synthetic Examples 8 to 11 were mixed with silica-free alumina hydrate particles of Synthetic Example 12 at ratios shown in Table 5. in the same manner as with Example 1, the obtained mixtures were mixed with polyvinyl alcohol and dispersed, coated and dried to obtain a recording medium with a 30 μm thick ink receiving layer formed thereon. Measurements and estimations of various characteristics were carried out respectively by the above methods. Results were shown in Tables 4 and 5.

### EXAMPLES 17 to 20

Silica-contained alumina hydrate particles obtained in Synthetic Examples 1, 2, 9 and 10 were used to obtain a dispersion of 15% by weight solid component by means of dispersion into ion exchange water in the same manner as in Example 1. Sodium chloride (available from Kishida Chemicals Co.) was added to this silica-contained alumina hydrate particle dispersion at the ratio of 1/150 of the solid component thereof and stirred in a manner similar to that of Example 1. To this dispersion, the same polyvinyl alcohol solution as that of Example 1 was further mixed as with Example 1 and stirred at 8,000 rpm for 10 minutes using the above homomixer to obtain a mixed dispersion. In the same manner as in Example 1, this mixed dispersion was applied to a substrate and the painted substrate was placed in an oven as with Example 1 and heated at 100° C. for 5 min to rapidly dry the neighborhood of the surface. Furthermore, after the drying while elevating the temperature up to 120° C. in the same oven, a recording medium with a 30 μm thick ion receptor layer formed was obtained. Measurements and estimations of various characteristics were carried out respectively by the above methods. Results were shown in Table 6.

### EXAMPLES 21 to 24

As a starting pulp, 80 parts of broadleaf tree bleached kraft pulp (LBKP) having a freeness (C.S.F.) of 370 ml and 20 parts of needle-blade tree kraft pulp (NBKP) having a freeness of 410 ml were used. To this as a filler, silica-contained alumina hydrate particles obtained in Synthetic Examples 1, 2, 9 and 10 were mixed at a ratio of 10% by weight to the solid component of pulp, cationized starch (CATOF, trade name, available from Oji National Co.) was internally added at a ratio of 0.3% by weight to the same solid component of pulp as an yield increasing agent and further 0.05% by weight of polyacryl amide yield increasing agent (Pearl Flock FR-X, trade name, available from Seiko Kagaku Kogyo Co., Ltd.) was added before the paper-making to make paper having a basis weight of 75 g/m² by using a TAPPI standard sheet former. Then, a 2% solution of oxidized starch (MS3800, trade name, available from Nihon Food Co.) was stuck by using a size press device and dried at 100° C. to obtain a recording medium. Concerning this recording medium, the results of measuring and estimating various characteristics are shown in Table 7. Incidentally, in the case of a paper substrate, since paper itself is of a porous structure, the overlap of many peaks makes the measurement of a pore structure difficult. Thus, no measurement was made.

### Comparative Examples 1 and 2

The coating liquids having compositions of Examples 2 and 6 described in Japan Patent Application Laid-Open No. 9-234948 were applied and dried on the same transparent PET in the same thickness as those of Example 1 to obtain the respective recording media of Comparative Examples 1 and 2. Concerning the recording media obtained in Comparative Examples 1 and 2, the results of measuring and estimating various characteristics are shown in Table 8. In both of them, the crystallinity was measured in a way similar to that of Examples of the present application, but no peak indicating the presence of a boehmite structure was obtained.

### Comparative Examples 3 and 4

By using the aluminosilicate described in Example 2 of Japanese Patent Application Laid-Open No. 5-58619, a coating liquid having the same composition as that of Example 1 was prepared, and then applied and dried on a transparent PET as with Example 1 at the same thickness as that of Example 1 (for Comparative Example 3). Besides, the aluminosilicate in this Example 2 of Japanese Patent Application Laid-Open No. 5-58619 was internally added in a paper by the same method as the above described in Example 21 (for Comparative Example 4). The results of measuring and estimating various characteristics are shown in Table 8. The surface of the aluminosilicate in the Example of Japanese Patent Application Laid-Open No. 5-58619 has been subjected to a doping treatment with aluminum. The crystallinity in the recording medium obtained by using the aluminosilicate in Example 2 of Japanese Patent Application Laid-Open No. 5-58619 was measured by the above way, however, any peak indicating a boehmite structure could not be obtained.

TABLE 1

| Aging | | | | | | |
|---|---|---|---|---|---|---|
| Conditions, | Synthetic | Synthetic | Synthetic | Synthetic | Synthetic | Synthetic |
| Measured Result | Example 1 | Example 2 | Example 3 | Example 4 | Example 5 | Example 6 |
| Hydrolysis | 110° C. | 110° C. | 110° C. | 110° C. | 110° C. | 110° C. |
| Temperature | | | | | | |
| Hydrolysis Time | 30 min.. | 30 min. | 30 min. | 30 min. | 30 min. | 30 min. |
| Mixing Ratio | 0.85 | 8.45 | 88.0 | 337 | 750 | None |
| (*1) | | | | | | |
| Silica Content | 0.1 | 1.0 | 10.0 | 29.0 | 47.0 | 0 |
| (% by weight) | | | | | | |
| Particle Shape | Plate-like | Plate-like | Plate-like | Plate-like | Plate-like | Plate-like |
| Average Particle | 30.2 | 27.1 | 24.6 | 22.5 | 20.0 | 30.5 |
| Diameter (nm) | | | | | | |
| Aspect Ratio | 6.0 | 6.1 | 5.7 | 5.1 | 4.7 | 6.1 |
| Crystallinity | 65 | 53 | 28 | 17 | 10 | 73 |
| Aging Conditions | Synthetic | Synthetic | Synthetic | Synthetic | Synthetic | Synthetic |
| Measured Result | Example 7 | Example 8 | Example 9 | Example 10 | Example 11 | Example 12 |
| Hydrolysis | 70° C. | 70° C. | 70° C. | 70° C. | 70° C. | 70° C. |
| Temperature | | | | | | |
| Hydrolysis Time | 180 min.. | 180 min. | 180 min. | 180 min. | 180 min. | 180 min. |
| Mixing Ratio | 0.85 | 8.45 | 88.0 | 337 | 750 | None |
| (*1) | | | | | | |
| Silica Content | 0.1 | 1.0 | 10.0 | 29.0 | 47.0 | 0 |
| (% by weight) | | | | | | |
| Particle Shape | Plate-like | Plate-like | Plate-like | Plate-like | Plate-like | Plate-like |
| Average Particle | 34.2 | 30.4 | 28.6 | 26.4 | 23.0 | 35.0 |
| Diameter (nm) | | | | | | |
| Aspect Ratio | 6.1 | 5.6 | 5.9 | 6.1 | 4.5 | 6.1 |
| Crystallinity | 68 | 55 | 30 | 19 | 11 | 73 |

*1: The mixing ratio between aluminum dodexide and ortho-silicic acid is the added amount of silicic acid to the 100 part of alkoxide (part by weight).

TABLE 2

| Manufacturing Conditions, Measuring | | | | |
|---|---|---|---|---|
| Item | Example 1 | Example 2 | Example 3 | Example 4 |
| Alumina Hydrate | Synthetic | Synthetic | Synthetic | Synthetic |
| | Example 1 | Example 2 | Example 3 | Example 4 |
| Crystallinity | 65 | 53 | 28 | 17 |
| Average Pore Radius (nm) | 8.0 | 8.2 | 8.3 | 8.5 |
| Half-Value Width (nm) | 5.0 | 5.0 | 5.0 | 5.0 |
| Pore radius distribution Peak 1 (nm) | 8.0 | 8.1 | 8.1 | 8.2 |
| Pore radius distribution Peak 2 (nm) | — | — | — | — |
| Volume Ratio of Peak 2 (%) | — | — | — | — |
| Greatest Peak (nm) | 8.0 | 8.2 | 8.3 | 8.5 |
| Water Absorbing Amount (cm³/g) | 0.60 | 0.60 | 0.60 | 0.60 |
| In-Plane Diffusion Coefficient | 0.60 | 0.60 | 0.60 | 0.60 |
| Pore Volume (cm³/g) | 0.60 | 0.60 | 0.60 | 0.60 |
| Pore Volume (cm³/m²) | 9.4 | 9.4 | 9.4 | 9.4 |
| Volume Ratio of 2.0-20.0 nm radius | 95 | 95 | 95 | 95 |
| Pores (%) | | | | |
| Ink Absorbency (*2) | AA, AA, AA | AA, AA, AA | AA, AA, AA | AA, AA, AA |
| Optical Density of Image (Bk) | 2.00 | 2.00 | 2.01 | 2.02 |
| Optical Density of Image (C) | 1.94 | 1.93 | 1.92 | 1.93 |
| Optical Density of Image (M) | 1.92 | 1.95 | 1.94 | 1.91 |
| Optical Density of Image (Y) | 1.95 | 1.90 | 1.96 | 1.92 |
| Solid-print Uniformity (*2) | A, A, A | A, A, A | A, A, A | A, A, A |
| Bleeding (*2) | A, A, A | A, A, A | A, A, A | A, A, A |
| Beading (*2) | A, A, A | A, A, A | A, A, A | A, A, A |
| Repelling (*2) | A, A, A | A, A, A | A, A, A | A, A, A |
| Tint Difference between Pigment and | A | A | A | A |
| Dye | | | | |
| Fixation | A | A | A | A |
| Density and Tint Difference (*2) | A, A, A | A, A, A | A, A, A | A, A, A |
| Post-Printing Curl | A | A | A | A |
| Post-Printing Tack | A | A | A | A |
| Post-Printing Conveyance Scratch | A | A | A | A |
| Post-Printing Powder drop-off | — | — | — | — |
| Haze (transparency) | 2.1 | 2.0 | 2.0 | 1.9 |
| Scratch | A | A | A | A |
| Crack | A | A | A | A |
| Powder drop-off | — | — | — | — |
| Curl | A | A | A | A |
| Tack | A | A | A | A |

*2: Estimated results of printers (a), (b) and (c) from the left.

TABLE 3

| Manufacturing Conditions, Measuring | | | | |
|---|---|---|---|---|
| Item | Example 5 | Example 6 | Example 7 | Example 8 |
| Alumina Hydrate | Synthetic | Synthetic | Synthetic | Synthetic |
| | Example 7 | Example 8 | Example 9 | Example 10 |
| Crystallinity | 68 | 55 | 30 | 19 |
| Average Pore Radius (nm) | 8.9 | 9.0 | 9.2 | 9.1 |
| Half-Value Width (nm) | 6.0 | 6.0 | 6.1 | 6.1 |
| Pore radius distribution Peak 1 (nm) | 10.0 | 10.2 | 10.5 | 10.3 |
| Pore radius distribution Peak 2 (nm) | 2.6 | 2.7 | 2.7 | 2.7 |
| Volume Ratio of Peak 2 (%) | 4 | 4 | 4 | 4 |
| Greatest Peak (nm) | 10.0 | 10.2 | 10.5 | 10.3 |
| Water Absorbing Amount (cm³/g) | 0.60 | 0.60 | 0.60 | 0.60 |
| In-Plane Diffusion Coefficient | 0.60 | 0.60 | 0.60 | 0.60 |
| Pore Volume (cm³/g) | 0.60 | 0.60 | 0.60 | 0.60 |
| Pore Volume (cm³/m²) | 9.0 | 9.0 | 9.0 | 9.2 |
| Volume Ratio of 2.0-20.0 nm radius | 90 | 90 | 90 | 90 |
| Pores (%) | | | | |
| Ink Absorbency (*2) | AA, AA, AA | AA, AA, AA | AA, AA, AA | AA, AA, AA |
| Optical Density of Image (Bk) | 2.01 | 2.00 | 2.00 | 2.01 |
| Optical Density of Image (C) | 1.92 | 1.93 | 1.94 | 1.91 |
| Optical Density of Image (M) | 1.94 | 1.93 | 1.96 | 1.93 |
| Optical Density of Image (Y) | 1.94 | 1.95 | 1.92 | 1.92 |
| Solid-print Uniformity (*2) | A, A, A | A, A, A | A, A, A | A, A, A |
| Bleeding (*2) | A, A, A | A, A, A | A, A, A | A, A, A |
| Beading (*2) | A, A, A | A, A, A | A, A, A | A, A, A |
| Repelling (*2) | A, A, A | A, A, A | A, A, A | A, A, A |
| Tint Difference between Pigment and | A | A | A | A |
| Dye | | | | |
| Fixation | A | A | A | A |
| Density and Tint Difference (*2) | A, A, A | A, A, A | A, A, A | A, A, A |
| Post-Printing Curl | A | A | A | A |
| Post-Printing Tack | A | A | A | A |
| Post-Printing Conveyance Scratch | A | A | A | A |
| Post-Printing Powder drop-off | — | — | — | — |
| Haze (transparency) | 2.0 | 1.9 | 2.0 | 2.0 |
| Scratch | A | A | A | A |
| Crack | A | A | A | A |
| Powder drop-off | — | — | — | — |
| Curl | A | A | A | A |
| Tack | A | A | A | A |

*2: Estimated results of printers (a), (b) and (c) from the left.

TABLE 4

| Manufacturing Conditions, Measuring | | | | |
|---|---|---|---|---|
| Item | Example 9 | Example 10 | Example 11 | Example 12 |
| Alumina Hydrate | Synthetic | Synthetic | Synthetic | Synthetic |
| | Example 2 + | Example 3 + | Example 4 + | Example 5 + |
| | Synthetic | Synthetic | Synthetic | Synthetic |
| | Example 6 | Example 6 | Example 6 | Example 6 |
| Mixing Ratio | 50:50 | 50:50 | 50:50 | 50:50 |
| Crystallinity | 63 | 50 | 45 | 40 |
| Average Pore Radius (nm) | 8.3 | 8.2 | 8.4 | 8.3 |
| Half-Value Width (nm) | 5.1 | 5.1 | 5.1 | 5.1 |
| Pore radius distribution Peak 1 (nm) | 8.1 | 8.1 | 8.3 | 8.2 |
| Pore radius distribution Peak 2 (nm) | — | — | — | — |
| Volume Ratio of Peak 2 (%) | — | — | — | — |
| Greatest Peak (nm) | 8.1 | 8.1 | 8.3 | 8.2 |
| Water Absorbing Amount (cm³/g) | 0.60 | 0.60 | 0.60 | 0.60 |
| In-Plane Diffusion Coefficient | 0.60 | 0.60 | 0.60 | 0.60 |
| Pore Volume (cm³/g) | 0.60 | 0.60 | 0.60 | 0.60 |
| Pore Volume (cm³/m²) | 9.4 | 9.4 | 9.4 | 9.4 |
| Volume Ratio of 2.0-20.0 nm radius | 95 | 95 | 95 | 95 |
| Pores (%) | | | | |
| Ink Absorbency (*2) | AA, AA, AA | AA, AA, AA | AA, AA, AA | AA, AA, AA |
| Optical Density of Image (Bk) | 2.02 | 2.00 | 2.00 | 2.01 |
| Optical Density of Image (C) | 1.93 | 1.90 | 1.95 | 1.94 |
| Optical Density of Image (M) | 1.95 | 1.93 | 1.94 | 1.93 |
| Optical Density of Image (Y) | 1.94 | 1.90 | 1.96 | 1.92 |
| Solid-print Uniformity (*2) | A, A, A | A, A, A | A, A, A | A, A, A |
| Bleeding (*2) | A, A, A | A, A, A | A, A, A | A, A, A |
| Beading (*2) | A, A, A | A, A, A | A, A, A | A, A, A |
| Repelling (*2) | A, A, A | A, A, A | A, A, A | A, A, A |
| Tint Difference between Pigment and | A | A | A | A |
| Dye | | | | |
| Fixation | A | A | A | A |
| Density and Tint Difference (*2) | A, A, A | A, A, A | A, A, A | A, A, A |
| Post-Printing Curl | A | A | A | A |
| Post-Printing Tack | A | A | A | A |
| Post-Printing Conveyance Scratch | A | A | A | A |
| Post-Printing Powder drop-off | — | — | — | — |
| Haze (transparency) | 2.1 | 2.0 | 2.0 | 2.0 |
| Scratch | A | A | A | A |
| Crack | A | A | A | A |
| Powder drop-off | — | — | — | — |
| Curl | A | A | A | A |
| Tack | A | A | A | A |

*2: Estimated results of printers (a), (b) and (c) from the left.

TABLE 5

| Manufacturing Conditions, Measuring | | | | |
|---|---|---|---|---|
| Item | Example 13 | Example 14 | Example 15 | Example 16 |
| Alumina Hydrate | Synthetic | Synthetic | Synthetic | Synthetic |
| | Example 8 + | Example 9 + | Example 10 + | Example 11 + |
| | Synthetic | Synthetic | Synthetic | Synthetic |
| | Example 12 | Example 12 | Example 12 | Example 12 |
| Mixing Ratio | 50:50 | 50:50 | 50:50 | 50:50 |
| Crystallinity | 64 | 51 | 45 | 40 |
| Average Pore Radius (nm) | 10.0 | 10.0 | 10.1 | 10.1 |
| Half-Value Width (nm) | 5.1 | 5.1 | 5.0 | 5.0 |
| Pore radius distribution Peak 1 (nm) | 10.2 | 10.1 | 10.3 | 10.5 |
| Pore radius distribution Peak 2 (nm) | 2.7 | 2.7 | 2.7 | 2.7 |
| Volume Ratio of Peak 2 (%) | 4 | 4 | 4 | 4 |
| Greatest Peak (nm) | 10.2 | 10.1 | 10.1 | 10.5 |
| Water Absorbing Amount (cm³/g) | 0.60 | 0.60 | 0.60 | 0.60 |
| In-Plane Diffusion Coefficient | 0.60 | 0.60 | 0.60 | 0.60 |
| Pore Volume (cm³/g) | 0.60 | 0.60 | 0.60 | 0.60 |
| (cm³/m²) | 9.0 | 9.0 | 9.0 | 9.2 |
| Volume Ratio of 2.0-20.0 nm radius | 90 | 90 | 90 | 90 |
| Pores (%) | | | | |
| Ink Absorbency (*2) | AA, AA, AA | AA, AA, AA | AA, AA, AA | AA, AA, AA |
| Optical Density of Image (Bk) | 2.02 | 2.01 | 2.00 | 2.00 |
| Optical Density of Image (C) | 1.95 | 1.92 | 1.95 | 1.94 |
| Optical Density of Image (M) | 1.94 | 1.93 | 1.92 | 1.93 |
| Optical Density of Image (Y) | 1.92 | 1.93 | 1.91 | 1.94 |
| Solld-print Uniformity (*2) | A, A, A | A, A, A | A, A, A | A, A, A |
| Bleeding (*2) | A, A, A | A, A, A | A, A, A | A, A, A |
| Beading (*2) | A, A, A | A, A, A | A, A, A | A, A, A |
| Repelling (*2) | A, A, A | A, A, A | A, A, A | A, A, A |
| Tint Difference between Pigment and | A | A | A | A |
| Dye | | | | |
| Fixation | A | A | A | A |
| Density and Tint Difference (*2) | A, A, A | A, A, A | A, A, A | A, A, A |
| Post-Printing Curl | A | A | A | A |
| Post-Printing Tack | A | A | A | A |
| Post-Printing Conveyance Scratch | A | A | A | A |
| Post-Printing Powder drop-off | — | — | — | — |
| Haze (transparency) | 2.0 | 2.0 | 2.0 | 2.0 |
| Scratch | A | A | A | A |
| Crack | A | A | A | A |
| Powder drop-off | — | — | — | — |
| Curl | A | A | A | A |
| Tack | A | A | A | A |

*2: Estimated results of printers (a), (b) and (c) from the left.

TABLE 6

| Manufacturing Conditions, Measuring | | | | |
|---|---|---|---|---|
| Item | Example 17 | Example 18 | Example 19 | Example 20 |
| Alumina Hydrate | Synthetic | Synthetic | Synthetic | Synthetic |
| | Example 1 | Example 2 | Example 9 | Example 10 |
| Crystallinity | 65 | 53 | 30 | 19 |
| Average Pore Radius (nm) | 8.5 | 8.2 | 9.2 | 9.1 |
| Half-Value Width (nm) | 5.0 | 5.0 | 6.1 | 6.1 |
| Pore radius distribution Peak 1 (nm) | 8.0 | 8.1 | 10.5 | 10.3 |
| Pore radius distribution Peak 2 (nm) | — | — | 2.7 | 2.7 |
| Volume Ratio of Peak 2 (%) | — | — | 4 | 4 |
| Greatest Peak (nm) | 8.0 | 8.2 | 10.5 | 10.3 |
| Water Absorbing Amount (cm³/g) | 0.70 | 0.70 | 0.70 | 0.70 |
| In-Plane Diffusion Coefficient | 0.9 | 0.9 | 0.9 | 0.9 |
| Pore Volume (cm³/g) | 0.60 | 0.60 | 0.60 | 0.60 |
| (cm³/m²) | 9.4 | 9.4 | 9.0 | 9.2 |
| Volume Ratio of 2.0-20.0 nm radius | 95 | 95 | 90 | 90 |
| Pores (%) | | | | |
| Ink Absorbency (*2) | AA, AA, AA | AA, AA, AA | AA, AA, AA | AA, AA, AA |
| Optical Density of Image (Bk) | 2.02 | 2.03 | 2.02 | 2.01 |
| Optical Density of Image (C) | 1.96 | 1.95 | 1.97 | 1.95 |
| Optical Density of Image (M) | 1.95 | 1.95 | 1.96 | 1.96 |
| Optical Density of Image (Y) | 1.97 | 1.96 | 1.96 | 1.94 |
| Solid-print Uniformity (*2) | A, A, A | A, A, A | A, A, A | A, A, A |
| Bleeding (*2) | A, A, A | A, A, A | A, A, A | A, A, A |
| Beading (*2) | A, A, A | A, A, A | A, A, A | A, A, A |
| Repelling (*2) | A, A, A | A, A, A | A, A, A | A, A, A |
| Tint Difference between Pigment and | A | A | A | A |
| Dye | | | | |
| Fixation | A | A | A | A |
| Density and Tint Difference (*2) | A, A, A | A, A, A | A, A, A | A, A, A |
| Post-Printing Curl | A | A | A | A |
| Post-Printing Tack | A | A | A | A |
| Post-Printing Conveyance Scratch | A | A | A | A |
| Post-Printing Powder drop-off | — | — | — | — |
| Haze (transparency) | 2.0 | 2.0 | 2.0 | 2.0 |
| Scratch | A | A | A | A |
| Crack | A | A | A | A |
| Powder drop-off | — | — | — | — |
| Curl | A | A | A | A |
| Tack | A | A | A | A |

*2: Estimated results of printers (a), (b) and (c) from the left.

TABLE 7

| Manufacturing Conditions, Measuring | | | | |
|---|---|---|---|---|
| Item | Example 21 | Example 22 | Example 23 | Example 24 |
| Alumina Hydrate | Synthetic | Synthetic | Synthetic | Synthetic |
| | Example 1 | Example 2 | Example 9 | Example 10 |
| Crystallinity | 65 | 53 | 30 | 19 |
| BET ratio surface area (m²/g) | — | — | — | — |
| Water Absorbing Amount (cm³/g) | 1.3 | 1.3 | 1.3 | 1.3 |
| In-Plane Diffusion Coefficient | 1.0 | 1.0 | 1.0 | 1.0 |
| Ink Absorbency (*2) | AA, AA, AA | AA, AA, AA | AA, AA, AA | AA, AA, AA |
| Optical Density of Image (Bk) | 1.35 | 1.33 | 1.32 | 1.34 |
| Optical Density of Image (C) | 1.28 | 1.31 | 1.32 | 1.30 |
| Optical Density of Image (M) | 1.31 | 1.30 | 1.31 | 1.31 |
| Optical Density of Image (Y) | 1.32 | 1.30 | 1.30 | 1.32 |
| Solid-print Uniformity (*2) | A, A, A | A, A, A | A, A, A | A, A, A |
| Bleeding (*2) | A, A, A | A, A, A | A, A, A | A, A, A |
| Beading (*2) | A, A, A | A, A, A | A, A, A | A, A, A |
| Repelling (*2) | A, A, A | A, A, A | A, A, A | A, A, A |
| Tint Difference between Pigment and | A | A | A | A |
| Dye | | | | |
| Fixation | A | A | A | A |
| Density and Tint Difference (*2) | A, A, A | A, A, A | A, A, A | A, A, A |
| Post-Printing Curl | A | A | A | A |
| Post-Printing Tack | A | A | A | A |
| Post-Printing Conveyance Scratch | — | A | A | A |
| Post-Printing Powder drop-off | A | — | — | — |
| Haze (transparency) | — | — | — | — |
| Scratch | — | — | — | — |
| Crack | — | — | — | — |
| Powder drop-off | A | A | A | A |
| Curl | A | A | A | A |
| Tack | A | A | A | A |

*2: Estimated results of printers (a), (b) and (c) from the left.

TABLE 8

| Manufacturing Conditions, Measuring | Comparative | Comparative | Comparative | Comparative |
|---|---|---|---|---|
| Item | Example 1 | Example 2 | Example 3 | Example 4 |
| Crystallinity | No boehmite | No boehmite | No | No |
| | structure | structure | boehmite | boehmite |
| | shown | shown | structure | structure |
| | | | shown | shown |
| Ink Absorbency (*2) | A, A, A | AA, AA, AA | A, A, A | AA, AA, AA |
| Solid-print Uniformity (*2) | A, A, A | C, C, C | C, C, C | C, C, C |
| Bleeding (*2) | C, C, C | C, C, C | C, C, C | C, C, C |
| Beading (*2) | C, C, C | A, A, A | C, C, C | A, A, A |
| Repelling (*2) | A, A, A | A, A, A | A, A, A | A, A, A |
| Tint Difference between Pigment and | C | C | C | C |
| Dye | | | | |
| Fixation | C | C | C | C |
| Density and Tint Difference (*2) | C, C, C | A, A, A | C, C, C | A, A, A |
| Post-Printing Curl | C | C | C | A |
| Post-Printing Tack | A | A | A | C |
| Post-Printing Conveyance Scratch | A | A | A | A |
| Post-Printing Powder drop-off | — | — | — | C |
| Haze (transparency) | 4.0 | 9.5 | 10.5 | — |
| Scratch | A | A | A | — |
| Crack | A | C | C | — |
| Powder drop-off | — | — | — | C |
| Curl | C | C | C | C |
| Tack | C | C | A | A |

*2: Estimated results of printers (a), (b) and (c) from the left.

The present invention exhibits the following noticeable effects.

(1) The occurrence of scratches by rubbing the surface of an ink receiving layer is preventable.

(2) The range of choice for ink becomes large, so that in printing either of an ink using a pigment or an ink using a dye, the uniformity is good and neither bleeding nor beading nor repelling occurs.

(3) Even when silica-contained alumina hydrate used singly, the fixation of a printed image is so good that no water-proofing agent such as a cationic resin is unnecessary. Besides, no doping treatment with aluminum or the like is also necessary.

(4) The range of choice for printing method becomes wider, so that there is no difference between the images printed by a small liquid-drop printer, by a large/small liquid-drop printer and by dense/dilute ink printer. Besides, in any of the printing methods, no change in tint accompanies a change in printing density.

(5) The transparency of an ink receiving layer can be improved. Besides, a recording medium good in ink absorbency and coloring performance and scant of crack, post-printing curl and tack is obtained.

(6) In the case of internal addition into a fibrous substance, a recording medium, excellent in ink absorbency and coloring performance and good in characteristics such as curl and tack can be obtained.

What is claimed is:

1. A recording medium comprising alumina hydrate, wherein said alumina hydrate having a boehmite structure and containing silica within alumina hydrate particles, in part of or a whole of said alumina hydrate particles, and crystallinity of said alumina hydrate obtained by an X-ray diffraction analysis of said recording medium is in a range of from 15 to 80.

2. The recording medium according to claim 1, wherein all of said alumina hydrate particles are silica-contained alumina hydrate particles.

3. The recording medium according to claim 2, wherein the content of silica to the whole amount of silica-contained alumina hydrate particles lies in a range of from 0.1 to 30% by weight.

4. The recording medium according to claim 1, wherein said alumina hydrate is a mixture of said silica-contained alumina hydrate particles and silica-free alumina hydrate particles, though having a boehmite structure, but containing no silica.

5. The recording medium according to claim 4, wherein the silica is contained ranging from 0.1 to 50% by weight based on the whole weight of silica-contained alumina hydrate particles.

6. The recording medium according to any of claims 1 to 5, comprising a substrate and an ink receiving layer provided on said substrate, wherein said silica-contained alumina hydrate particles are contained in said ink receiving layer.

7. The recording medium according to claim 6, wherein said silica-contained alumina hydrate particles are contained in the top surface of said ink receiving layer.

8. The recording medium according to any of claims 1 to 5, comprising a fibrous layer wherein said silica-contained alumina hydrate particles are internally added into said fibrous layer.

9. The recording medium according to claim 8, wherein said silica-contained alumina hydrate particles are internally added near the surface of or in the surface down to the interior of said fibrous layer.

10. An image forming method for recording by ejecting an ink through a minute orifice and depositing it to a recording medium, wherein a recording medium according to claim 1 is used as the recording medium.

11. The image forming method according to claim 10, wherein an ink is ejected by applying thermal energy to the ink.
